(19) United States
(12) Patent Application Publication
(10) Pub. No.: US 2022/0185000 A1
(43) Pub. Date: Jun. 16, 2022

(54) DECORATIVE CONTAINER WITH MULTIPLE FUNCTIONS

(71) Applicant: Celeste Stephanie Costello, Temple, GA (US)

(72) Inventor: Celeste Stephanie Costello, Temple, GA (US)

(21) Appl. No.: 17/547,491

(22) Filed: Dec. 10, 2021

Related U.S. Application Data
(60) Provisional application No. 63/123,555, filed on Dec. 10, 2020.

(51) Int. Cl. B44C 1/10; B44D 2/00; F21V 35/00

(52) U.S. Cl. CPC B44C 1/105; F21V 35/00; B44D 2/00

(57) ABSTRACT

A candle Vessel/Container with a one-of-a-kind original art painting adhered to outer surface of vessel and epoxy applied to complete outer surface for years of protection of art. Vessel is shatterproof due to epoxy coating. Typical wick base, wick, and fuel (i.e. soy wax) is installed along with decorative top-surface medallion to complete candle.

### CROSS-REFERENCE TO RELATED APPLICATIONS

This application claims the benefit of priority to U.S. Provisional Application Serial No. 63/123,555, filed on Dec. 10, 2020, entitled “Candle Original Art Vessel/Container with Dual Purpose,” the entire contents of which are hereby incorporated by reference herein.

### TECHNICAL FIELD

The present subject matter relates generally to containers, and more particularly, to decorative containers having multiple functions of which a first function is supporting a candle.

### BACKGROUND

Candles may be characterized by their form; composite candles, (e.g. candles containing zones of different composition, inclusions, or the like) and can include, but are not limited to, decorative, aesthetic, novelty, segmented, etc. and other composite features.

Candles have been available for centuries and have been typically promoted and used as both utilitarian and decorative. The present invention serves consumers with not only a utilitarian-type candle, but also serves as a unique decorative one-of-a-kind art piece with a plurality of purposeful uses once the fuel is spent.

The present invention is not intended to be discarded once its original fuel has expired, thus providing savings to consumer relating to repeated purchases. While many types of candles are produced en masse today, a need has arisen for candles that are unique, Artistic, and that incorporate more than one purpose (e.g. not disposable).

These and other features will become apparent to those having ordinary skill in the art of candle-making through this disclosure.

### SUMMARY

Aspects and advantages of the invention will be set forth in part in the following description, or may be obvious from the description, or may be learned through practice of the invention.

According to some aspects, a container is disclosed. The container comprises: a sealed base; a cylindrical wall extending from the base; an upper rim formed on the cylindrical wall; an artwork area having a first adhesive mixture applied thereon, the artwork are encompassing a portion of the cylindrical wall; a rectangular piece of original artwork applied onto the first adhesive mixture; a second adhesive mixture applied onto the rectangular piece of original artwork; a sealant layer applied onto the second adhesive mixture; and an interior cavity, defined by the sealed base, cylindrical wall, and upper rim, the interior cavity being at least partially filled, below the upper rim, with at least one candle wick and a measure of candle wax sufficient to hold the candle wick once fully cured.

In some embodiments, the container is formed of glass.

In some embodiments, the artwork area encompasses a majority of the cylindrical wall from the sealed based to the upper rim.

In some embodiments, the rectangular piece of artwork is a piece of acrylic artwork formed by an acrylic pour process and from acrylic paint.

In some embodiments, the piece of acrylic artwork is peeled or pulled away from a first painting substrate prior to being applied to the first adhesive mixture.

In some embodiments, the peeled or pulled piece of acrylic artwork is trimmed to match the dimensions of the artwork area.

In some embodiments, the first adhesive mixture and the second adhesive mixture are fully cured mixtures of adhesive.

In some embodiments, the fully cured mixtures of adhesive were formed of equal parts of water and clear glue prior to fully curing.

In some embodiments, the sealant layer is a fully cured layer of sealant.

In some embodiments, the fully cured layer of sealant is an epoxy material.

According to another aspect, a candle container is disclosed. The candle container comprises a sealed based, a cylindrical wall extending from the base, and an upper rim formed on the cylindrical wall. The candle container has an interior cavity defined by the sealed base, cylindrical wall, and upper rim. The candle container is formed by a process of: applying a first adhesive mixture to an artwork area, the artwork are encompassing a portion of the cylindrical wall; applying a rectangular piece of original artwork onto the first adhesive mixture prior to the first adhesive mixture curing; applying a second adhesive mixture onto the rectangular piece of original artwork; applying a sealant layer applied onto the second adhesive mixture; and at least partially filling, to approximately below the upper rim, the interior cavity with at least one candle wick and a measure of candle wax sufficient to hold the candle wick once fully cured.

In some embodiments, the container is formed of glass.

In some embodiments, the artwork area encompasses a majority of the cylindrical wall from the sealed based to the upper rim.

In some embodiments, the rectangular piece of artwork is a piece of acrylic artwork formed by an acrylic pour process and from acrylic paint.

In some embodiments, the piece of acrylic artwork is peeled or pulled away from a first painting substrate prior to being applied to the first adhesive mixture.

In some embodiments, the peeled or pulled piece of acrylic artwork is trimmed to match the dimensions of the artwork area.

In some embodiments, wherein the first adhesive mixture and the second adhesive mixture are not fully cured when applying the original artwork and the sealant layer, respectfully.

In some embodiments, the first adhesive mixture and the second adhesive mixture are formed of equal parts water and clear glue.

In some embodiments, the sealant layer is allowed to fully cure prior to filling the interior cavity.

In some embodiments, the sealant layer is an epoxy material.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a side view of a cylindrical container, in accordance with example embodiments of this disclosure.

FIG. 2A illustrates a rectangular container for creating original artwork, in accordance with example embodiments of this disclosure.

FIG. 2B illustrates original artwork deposited in the rectangular container of FIG. 2A.

FIG. 3 illustrates the original artwork of FIG. 2B after having been removed from the rectangular container of FIG. 2A.

FIG. 4 is a side view of a container with initial adhesive applied, in accordance with example embodiments of this disclosure.

FIG. 5 is a side view of a container having original artwork applied onto the initial adhesive, in accordance with example embodiments of this disclosure.

FIG. 6 is a side view of a container having a secondary adhesive applied onto the applied original artwork, in accordance with example embodiments of this disclosure.

FIG. 7 is a side view of a container having a candle formed of wax and wick deposited therein, with secondary adhesive having fully cured, and with an optional sealant applied thereon, in accordance with example embodiments of this disclosure.

FIG. 8A is a side view of a container with a candle deposited therein, and a separate decorative medallion deposited onto the candle, in accordance with example embodiments of this disclosure.

FIG. 8B is a top view of an example, separate decorative medallion deposited onto a candle surface, in accordance with example embodiments of this disclosure.

FIG. 9 is a flowchart of a method of creating a candle container having a plurality of functions, in accordance with example embodiments of this disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). Furthermore, as used herein, terms of approximation, such as “approximately” or “substantially,” refer to being within a ten percent margin of error.

Containers for candles may include rectangular and/or cylindrical containers, typically formed of glass or heat-resistant material. Candles may be decorative and include artwork printed thereon through industrial processes. These candles may be mass-produced and lack any features allowing customization by an original artist.

However, according to the aspects presented herein, the present disclosure provides a candle vessel and/or container with a unique, one-of-a-kind, original artwork encapsulated and preserved by epoxy over entire outer wall surface of vessel.

Upon expiration of candle fuel, the candle vessel and/or container can be cleaned and made ready for further use. A secondary use is for example, but not limited to, a flower vase. A tertiary use is for example, but not limited to, refilling the candle vessel and/or container with another appropriate wick holder, wick, and fuel. These and other features enable the candle vessel and/or container to have recurring uses instead of disposing of the same (e.g. container is reusable). Other features including an epoxy coating aids in the candle's longevity as well as making it shatter resistant and/or shatterproof.

The present invention could easily sit empty on a shelf, and still provide a unique vessel/container of interest with its original encapsulated artwork. The many uses of the empty candle Vessel/Container are limited only by the user's imagination.

Accordingly, technical benefits and effects of the present disclosure include reduced waste, increased aesthetics, increased recycling opportunities, as well as improved user satisfaction.

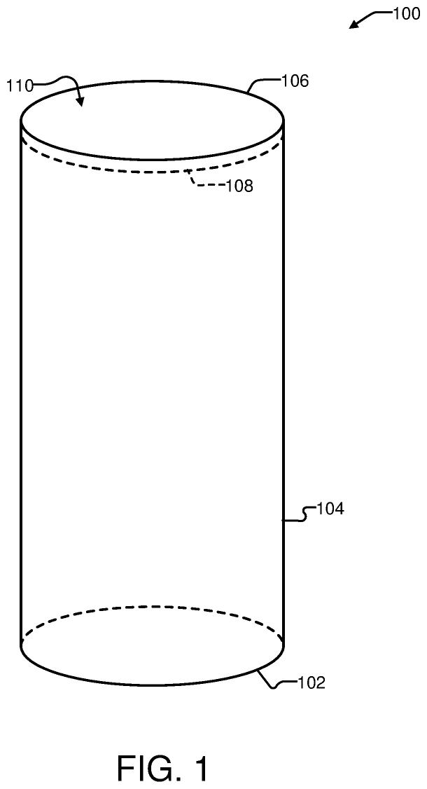

FIG. 1 is a side view of a simple, empty, cylindrical candle container 100. The container 100 may include a sealed base 102, cylindrical wide wall 104 extending from the sealed base 102, and an upper cylindrical lip 106 formed on the cylindrical side wall 104. An outer lip 108 may be apparent on some, but not all, cylindrical containers. The sealed base 102, cylindrical wall 104, and upper lip 106 define a generally cylindrical interior 110 that is operative to receive candle wax, candle wick, and other candle features. It is noted that upon expiration of any candle fuel (e.g., wax, soy wax, etc.), the interior 110 may be used for a plurality of functions including, but not limited to, holding flowers (both live flowers and ornamental flowers), drinking fluids, decorative uses, and other functions.

The candle container 100 may be first prepared by thoroughly cleaning the inside and outer surface walls of container 100 to reduce and/or eliminate any surface dirt. A simple solution such as dish soap and water can be useful in cleaning and preparation.

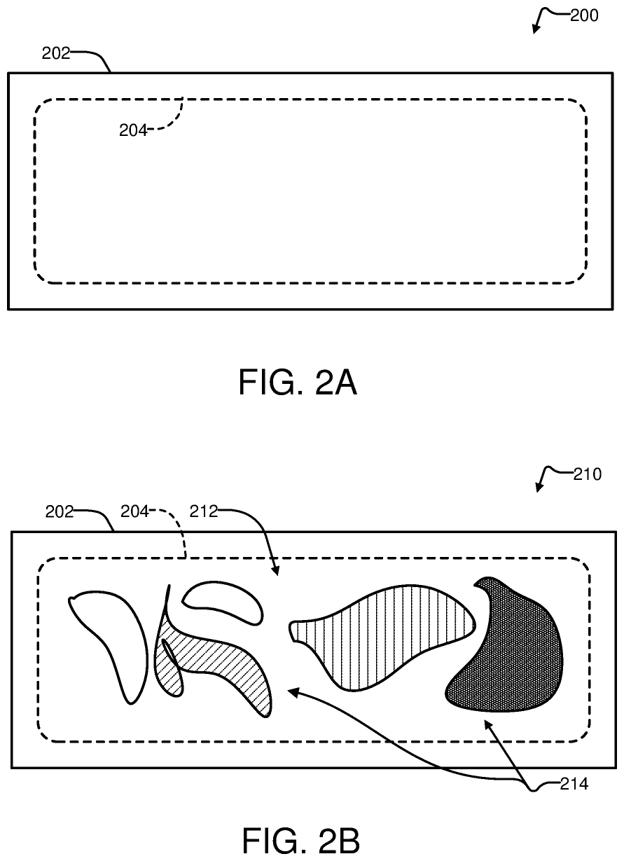

FIG. 2A illustrates a generally rectangular container 200. The container 200 may include any flat piece of any type of thick, heavy plastic that can be used as a substrate for the painting. Preferably, the plastic substrate has a lip 202 (e.g., a TUPPERWARE ® type food container top) to contain paint and prevent spreading too thin, overflowing, and wasting of paint. A lip could also be made by using silicone and a silicone gun to form the sides in a free hand manner Appropriate drying time for silicone is necessary before creating the painting. The substrate should be at least slightly larger than the contemplated finished painting dimensions.

The minimal over-sizing of the substrate allows the Artist to make refinements around the edges to reach the desired finished measurement of the painting. Most times the aesthetics of the painting's parameters will steer the Artist as to what and where along the sides of the painting they want an outline that is to be to cut away (e.g., dotted line 204).

It is suggested to spray a light coat of “mold release” to substrate before the paint is poured. This will greatly assist in peeling off the painting in one piece from substrate once dried.

FIG. 2B illustrates original artwork 212 deposited in the rectangular container 200 of FIG. 2A. As illustrated, different artistic designs 214 may be painted directly onto the substrate 200 (or onto a mold-release sprayed substrate).

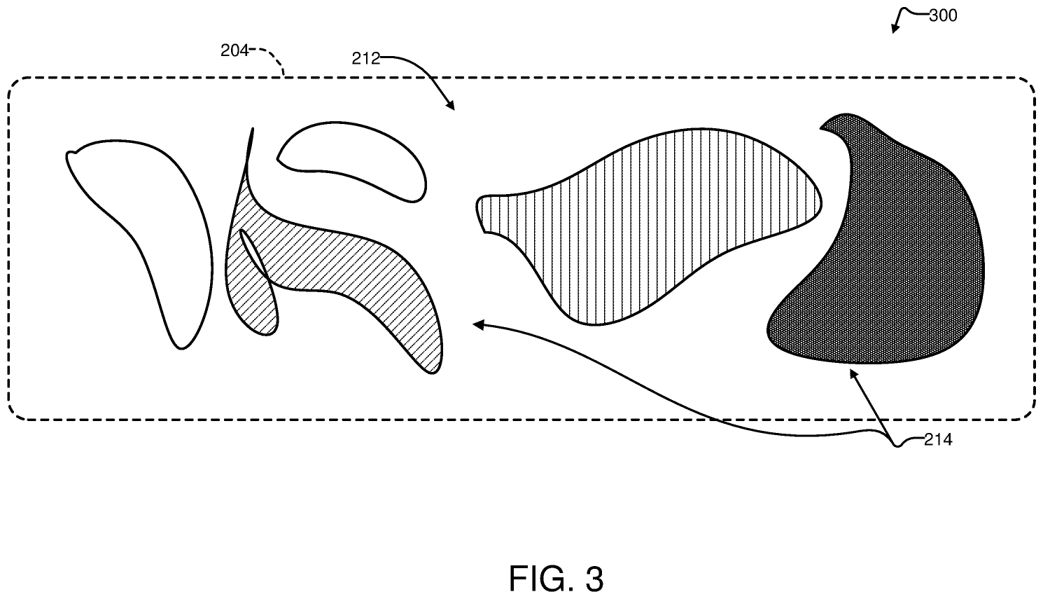

FIG. 3 illustrates the original artwork 300 of FIG. 2B after having been removed from the rectangular container of FIG. 2A. For example, 300 may represent an Artist's abstract painting created separately from the candle Vessel/Container 100 and within the lip 202 of substrate 200 according to an example embodiment of the present disclosure. The type of painting method used in this present invention is currently termed in the art world as an “acrylic pour.” However, the Artist is not limited to the acrylic pour method according to an embodiment of the present invention. Any art medium can be used to create the art piece that will be attached to the vessel.

The Artist prepares the desired acrylic colors for each individual artwork (e.g., 214) and each color will be prepared in its own separate container once the base volume is mixed. The volume of paint necessary to completely cover substrate work area is easily determined by paint calculators available on the Internet. Volume of paint can be determined by measuring length x width x depth of paint thickness desired of substrate 200 and lip 202.

Different colors can be mixed to have different fluidities dependent upon how the Artist desires the paint to move. The less viscous, the less fluid the paint across substrate. The more thinned out paint the better the flow of paint across substrate. This takes much practice. The process for preparing the various colors of acrylic paint includes but is not limited to diluting the acrylic paint with various commercial pouring mediums, as well as water, to reach the Artist's desired thickness to enable the paint to flow easily across the plastic substrate 200.

Each acrylic color that has been prepared is then poured and layered into one cup large enough to hold the volume of paint necessary for completing the painting, in one pour, and currently being created and in layers and sequence the artist has planned.

According to an embodiment of the present invention, the Artist pours the large cup of layered paint onto the substrate 200 in any direction or fashion desired. There are voluminous techniques to this type of acrylic pour such as the “dirty pour,” a “flip cup” method etc. and is the Artist's choice. Spraying a commercial mold release to substrate 200 before the paint is poured will greatly assist in the peeling off the painting from substrate once dried (e.g., as shown in FIG. 3). The Artist then manipulates the paint by tilting substrate to different sides, back and forth of the substrate until satisfied with the design. Other reactive techniques can also be performed at this stage of creating such as “swiping” the already poured paint for further resultant patternings by means of using any material that can stand up to the paint and not buckle when swiping (e.g. a thin edge of plastic such as a coated playing card, wax paper, wood sticks etc.).

According to an embodiment of the present invention, it is important at this wet stage of the acrylic pour, to add any other embellishments desired so they can dry in and along with the paint. A popular embellishment is glitter but is not limited to same. There is a wide variety of embellishment choices available including, but not limited to, glitter, salts, plastics, stickers, beads, pieces of glass/plastic, metals, metallic beads, and other embellishments.

The completed painting is then set aside, covered to prevent hair and dust particles from landing on wet paint and to dry naturally in an ambient air of at approximately 70. F and low humidity, if possible. The drying of the painting on substrate 200 at this temperature typically takes three days, but is also dependent upon thickness of paint poured. Abstract, organic, and a galaxy type look are but a few examples of what “look” the Artist is trying to achieve.

The artwork 300 can be peeled away from substrate 200 after drying and where the artwork has been cut to size (e.g., along dotted line 204) to fit an exterior surface of the container 100.

If the underlying surface of painting is still tacky, whatsoever, when trying to pull painting off substrate, then further drying time is required. It is easy to tell if acrylic painting is properly dried when one starts to peel painting away from the substrate and the underside is revealed.

The acrylic painting piece 300 that has now been sized, is ready to be adhered to the candle container 100. However, a choice presents itself to the Artist at this juncture, relative to using the front side vs. reverse side of painting to be adhered to container 100. Many an acrylic painting backside, once peeled from substrate 200, can turn out to be the more exciting art piece to choose as the final painting side. Each candle's artwork will always have two sides of art but because of the candle's fuel that is poured during finishing steps and solidified, the reverse side will not be seen until the fuel is burned away in the normal course of use.

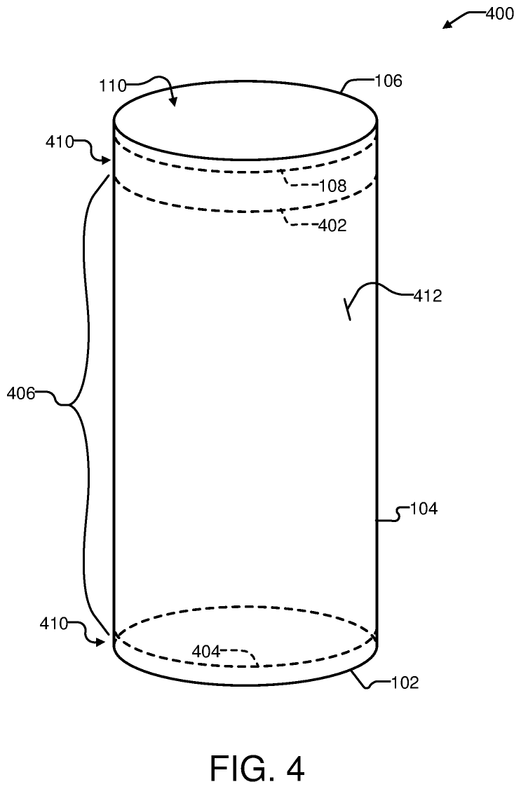

FIG. 4 is a side view of a container 400 with initial adhesive applied, in accordance with example embodiments of this disclosure. The adhesive solution is painted on an exterior surface 406. This area 406 is defined by the dimensions of the container 100, and may include an upper border 402, a lower border 404, and may optionally include spaces 410. The spaces 410 may be omitted entirely if the entire outer surface of the container 100 is to be covered. The adhesive solution may include a solution of approximately 50% water and 50% glue, in some implementations.

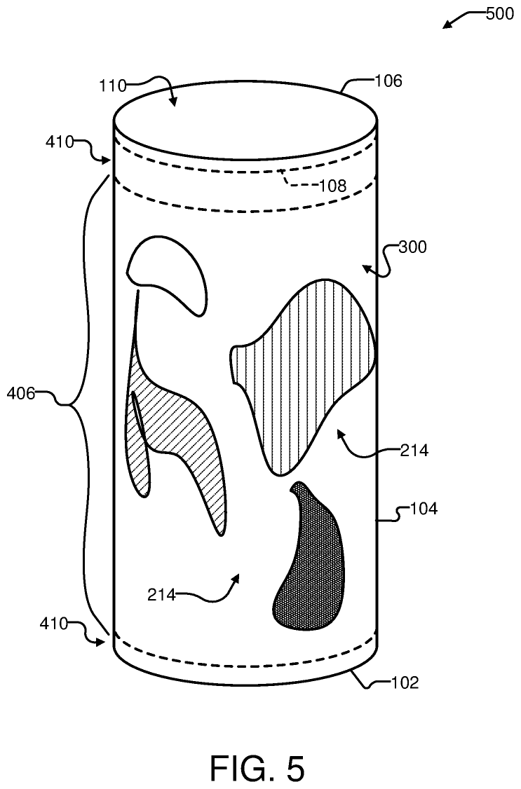

FIG. 5 is a side view of a container 500 having original artwork applied onto the initial adhesive, in accordance with example embodiments of this disclosure. As shown, an artist takes the prepared acrylic painting piece 300 that has been cut to size and wraps it around container 100 while glue mixture is still wet, or at least tacky, and evenly spaces it between bottom and top (e.g., between spaces 410). Spacing of painting between bottom and top of vessel is approximate, not meant to be “perfect.” An organic feel is desired of most implementations of the product. Smoothing of the painting with hands along vessel maybe necessary at this point to remove air pockets under the wrapped painting 300. The painting is easy to manipulate around because of the glue mixture still being wet or tacky at this point.

The painting edges are carefully stretched if necessary, to close the gap where the two edges meet. The correct measurements should prevent problems here. Sometimes the edges may overlap if Artist feels it aesthetically pleasing due to the particular design at hand. The candle Vessel/Container should now have at least a half-hour drying time for glue before proceeding to next step.

It is also at this point in the process where Artist should make any last aesthetic adjustments necessary to adhered painting to reach a finished look. This could entail something as small as cutting a bit of acrylic paint off with a razor around the top or bottom of the abstract painting to make the top lines appear neater. At times bubbles can reappear at the drying stage, seemingly out of nowhere, and will need to be eradicated for a smoother finish. This is best achieved by piercing the bubble with a razor point to let air out and then pressing flat with a finger to flatten out surface bubble. However, the nature of this type of painting will have some high-low areas due to thickness of paint and embellishments added that may protrude, this is normal. Whatever areas that detract from the appeal and look of a finished painting can now be taken care of, prior to full curing of the initial adhesive layer.

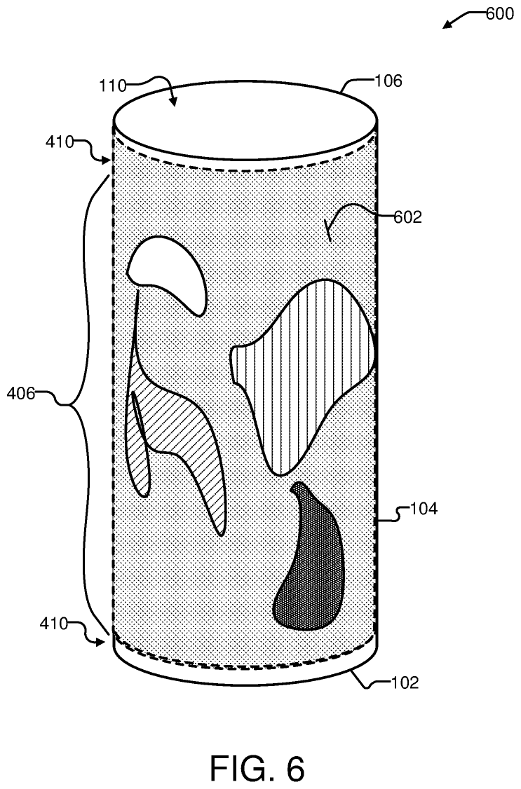

FIG. 6 is a side view of a container having a secondary adhesive 602 applied onto the applied original artwork 300, in accordance with example embodiments of this disclosure.

As illustrated, a second application of the adhesive mixture (e.g., 50/50 clear liquid glue and water mixture) is applied to the entire outer surface of container 100, being sure to get all high/low areas of adhered painting and embellishments. This step is necessary due to acrylic paint's nature to repel sealants and/or epoxy from its surface. This step is critical in aiding the epoxy coat to look smooth without “craters” and areas where epoxy could pull away from adhered painting. Drying time at this stage is approximately ½ hour or “dry to touch.”

The container 600 is now placed horizontally onto a commercial electric bottle spinner (many brands available on Internet) that very slowly turns the container as the epoxy is slowly poured/trickled over candle Vessel/Container until completely covered from base to top rim.

According to an embodiment of the present invention, approximately ¾ ounce of epoxy and ¾ oz. of hardener will cover a cylindrical vessel that is 6″ tall by 3.3″ diameter as is used for the present invention. The artist will have to calculate the epoxy needed for each project. Epoxy calculators are easily accessible on the Internet.

As the mixed cup of epoxy is held above the now slowly spinning bottle turner with vessel, the epoxy should slowly trickle out of cup, moving slowly from base of vessel 102 to vessel's top rim 106. A gloved index finger is best used to guide the epoxy over the surface as evenly as possible. It is practical to note here that most, if not all epoxy brands, state their epoxy is “self-leveling.” So once the artist is satisfied enough epoxy has been applied and, in a thickness, to enable a smooth coating of epoxy over entire vessel, the bottle spinner will be left on until the epoxy levels out and dries to the touch. Most epoxies will dry to touch in approximately 5 hours.

A heat gun should be used at least a couple of times to pop bubbles in the epoxy as it turns on the spinner. It is not always possible to pop all bubbles all the time and on every vessel. Bubbles are just an inherent property of epoxy, especially if one mixes the epoxy with a heavy hand. The slower the epoxy parts are mixed; the less amount of bubbles will form. Heating epoxy up during mixing can also aid in popping bubbles but also factors in the curing time by minutes.

One can also place the container that is being used to mix the two epoxy parts into a larger container that has hot, but not boiling water. This heated water helps the consistency to be even more fluid and easier to pour and helps eliminate bubbles. It only takes about 30 seconds in a heated water bath and should be taken back out of water, not left to sit. Another important note about epoxy is it hates water so be extra careful not to let any water droplets accidentally fall into epoxy that is being mixed. Different epoxies have their own specified drying time as well as their own “pot time.” Pot time is critical to note for each brand of epoxy. This simply means the amount of time to work with epoxy before it starts to cure and is no longer easy to work with. The heating of epoxy after mixing is normal as it cures. This is a delicate dance the artist must practice.

Epoxy covered container 600 is to continue spinning until at least dry to the touch. At that point, the bottle spinner can be turned off to save wear and tear. It is recommended to cover the vessel while on bottle spinner to avoid dust, hair, and other particles from landing on wet epoxy.

The final inspection before applying epoxy coat can entail cutting away with a razor, any areas of acrylic paint at the top, bottom or seam of painting that may look ragged. Many epoxies currently on the market can be used for this present invention and all have their own specifications to follow that are key to proper epoxy curing. Future epoxy formulas on the market will be considered for the present invention and may replace currently used brands if they provide a better and more durable outer coating for the art piece and better protection from glass shattering and splintering when dropped. The epoxy, after proper curing, renders the glass candle Vessel/Container shatterproof. A great asset for the safety of the consumer according to an embodiment of the present invention.

Epoxy varies in complete curing times, typically from 12 to 72 hours to become extremely solid and resist fingerprints, nicks, and bumps when handling. The resultant hard coat of epoxy provides an extra safety net for the glass candle container 600 and safeguards it from shattering and/or splintering of glass if dropped. This epoxy protection layer provides consumers with a much longer lasting usefulness and durability of a finished, cured container 100. This is a great safety feature the epoxy coating creates to prevent shattering and slivers of glass to fly about when dropped.

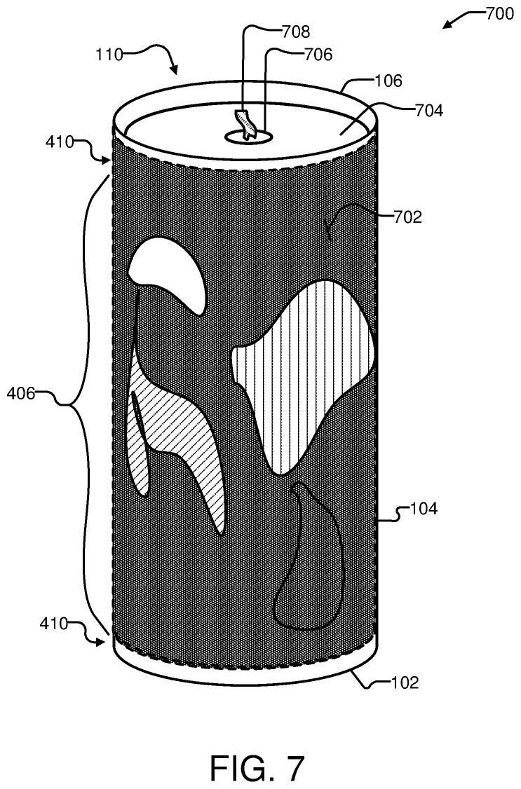

FIG. 7 is a side view of a container having a candle formed of wax 704 and wick 708 deposited therein within approximately center 706 of the wax 704. As further illustrated, an epoxy coating 702 is fully cured on the exterior surface of the container 700, with secondary adhesive having fully cured, and with an optional sealant (e.g., epoxy 702) applied thereon, in accordance with example embodiments of this disclosure.

If consumer desires to refill the candle Vessel/Container with whatever fuel product they desire, the best process to achieve this would be to put candle Vessel/Container 700 in a double boiler to melt down all residual fuel (e.g. soy wax) and simply pour out along with spent wick and wick base. A subsequently cleaned and prepared candle Vessel/Container is ready for its next use, whether it be it a new candle fill, flower vase or other purposeful use the consumer desires.

It is noted that the sealant layer 702 may be hand applied over the entire surface of container 700 and painting 300 to permanently preserve the artwork. A curing period is required of the epoxy resin for a time frame of 12 to 72 hours, dependent upon what brand of epoxy resin is used, before the candle fuel and wick can be installed.

AN additional feature of the present disclosure may include an offer of service to consumers to return candle containers 700 back for candle fuel to be refilled after a thorough cleaning process.

It is noted that the amount of fuel used to pour into container 700 is defined by the Vessel/Container's shape, height, and width. The present invention's volume of fuel provides for a very long-lasting candle burn due to large sizes of Vessel/Containers, ranging in height from 6-9″ glass and typically a 3.3″ diameter Vessel/Containers. Twenty-four (24) ounces soy wax is typical for the present invention with a height of 6″ and a 3.3″ diameter. The present invention's Vessel/Container is not limited to above stated measurements but present an ideal height for the original paintings that will be adhered to them. Taller vessels can be used, and sizing of finished artwork would be adapted accordingly.

According to an embodiment of the present invention, the cured vessel is ready to receive a wick base, wick, and candle fuel to further complete the artistic candle Vessel/Container. In the present invention, 24 ounces of soy wax is melted in a double boiler setup. Once the soy wax is completely melted, it is then brought to a heated temperature of 185° F. and then taken away from heat source. Fragrance is immediately added and stirred by hand for 2 minutes to assure binding of fragrance to soy wax particles. If coloring is to be used it also can be added at this point. The soy wax, fragrance and/or coloring are left to cool down to a temperature between 135-145° F. At this point, the soy wax mixture can be slowly poured into prepared candle Vessel/Container in one, slow pour. Afterwards, additional embellishments including wax medallions may be placed onto the candle surface.

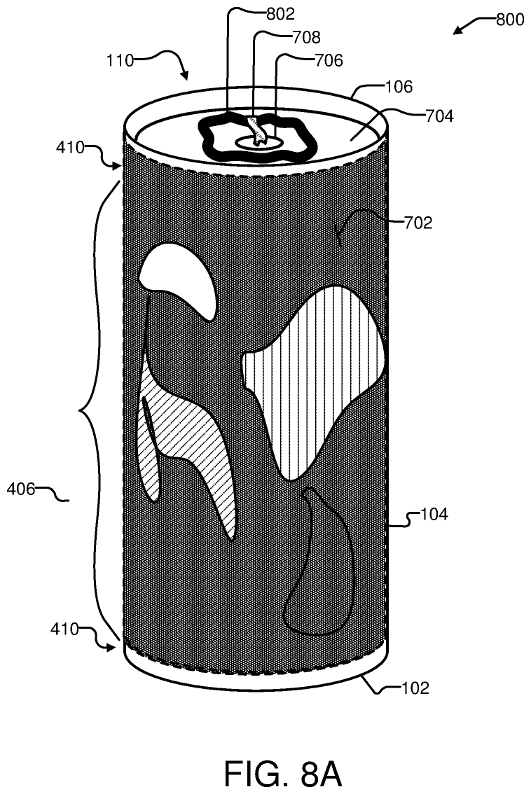

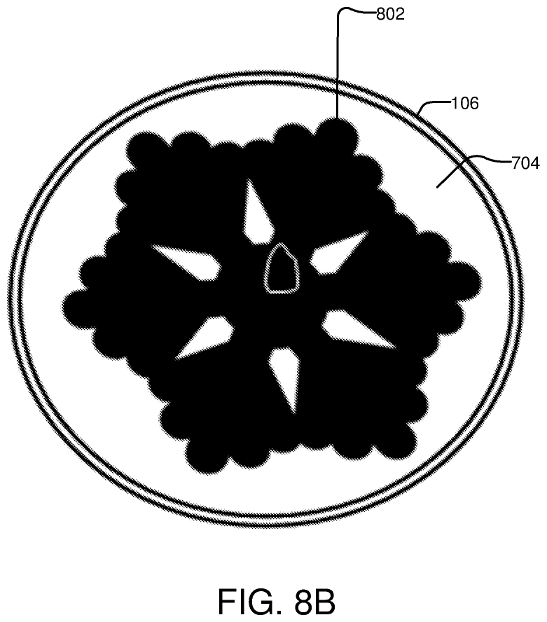

FIG. 8A is a side view of a container with a candle deposited therein, and a separate decorative medallion 802 deposited onto the candle, in accordance with example embodiments of this disclosure. FIG. 8B is a top view of an example, separate decorative medallion 802 deposited onto a candle surface, in accordance with example embodiments of this disclosure.

The medallions 802 are made separate and apart from the candle Vessel/Container by melting soy wax, adding fragrance and color as described above and poured into an already existing mold and left to harden at least an hour. Once hardened, the medallion 800 can then be taken out of its mold and installed onto surface of candle wax 704.

A hole is created in the middle of the wax decorative medallion by taking a simple metal skewer, such as one you would use to grill with, hold it over gas burner on stove or other flame/heat source to make hot enough to pierce medallion 802 in middle. The candlewick 708 can be threaded through decorative medallion 802 and brought down to rest on wax surface 704. However, before threading medallion 802 all the way down, take heat gun and move across surface of wax until it is slightly melted on surface, only enough to receive the medallion 802 without making a puddle or indentation after medallion is placed on surface.

The medallion 802 will now be held in place permanently and the wick 708 can be cut to size once the top surface of wax 704 is once again hardened. The decorative medallion 802 will melt and pool the same as without the medallion 802 on top. The soy wax medallion 802 does not interfere with the normal burn and melt pool of candle, it simply adds a temporary decoration and additional wax to burn. Glitter can be sprinkled on the top of medallion 802 since glitter is lighter in weight than the soy wax and will simply float on wax.

There are many readily available molds on the market that can be purchased and used to make decorative medallions for the adornment of these candles. Original artwork molds can also be made by artist as well for even further originality and high-end candles.

Hereinafter, a method of producing an original artwork candle container, such as the finished container 700, in accordance with example embodiments of this disclosure.

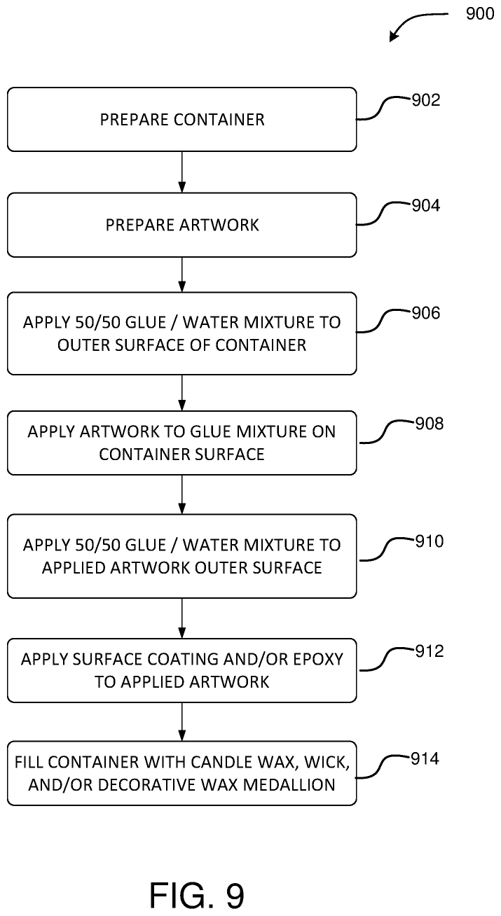

FIG. 9 is a flowchart of a method 900 of creating a candle container 700 having a plurality of functions, in accordance with example embodiments of this disclosure.

The method 900 comprises, preparing container 100, at step 902. The preparing may include thoroughly cleaning the container 100 with a dish soap cleaner, wax remover, or other cleaner.

The method 900 also comprises preparing original artwork 300 in a container/substrate 200, at step 904. The steps 902 and 904 may be performed separately and/or in parallel. The step 904 comprises the “acrylic pour” sub-method described in detail herein. Other painting methods are also applicable.

The method 900 further comprises applying an initial adhesive mixture 412 of equal parts clear glue and water to the exterior cylindrical surface of the container 200, as shown in FIG. 4, at step 906. It is noted that while the initial mixture 412 is still wet and/or tacky, step 908 is performed, below.

The method 900 further comprises applying the cut, original artwork 300 to the initial adhesive mixture 412, on the exterior cylindrical surface of the container, at step 906.

The method 900 also comprises applying a second, adhesive mixture onto the surface of the applied artwork, at step 910. The second adhesive mixture 612 can be the same as the initial adhesive mixture 412, as shown in FIG. 6.

The method 900 further comprises applying a surface coating 712, such as sealant and/or epoxy, to the surface of the applied artwork and second adhesive layer, at step 912.

Thereafter, and upon appropriate curing steps and alterations described in detail above, the finished container 700 may be filled with candle wax and wick, and a decorative medallion can be optionally placed thereon, at step 914.

As described in detail herein, original artwork-based containers may include an initial function as a candle, and subsequent to initial use of the candle functionality, may be re-used for a plurality of functions including, but not limited to: refilling as anew candle, use as a drinking vessel, use as a flower vase, use as a decorative glassware item, and other uses.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A container, comprising:
a sealed base;
a cylindrical wall extending from the base;
an upper rim formed on the cylindrical wall;
an artwork area having a first adhesive mixture applied thereon, the artwork are encompassing a portion of the cylindrical wall;
a rectangular piece of original artwork applied onto the first adhesive mixture;
a second adhesive mixture applied onto the rectangular piece of original artwork;
a sealant layer applied onto the second adhesive mixture; and
an interior cavity, defined by the sealed base, cylindrical wall, and upper rim, the interior cavity being at least partially filled, below the upper rim, with at least one candle wick and a measure of candle wax sufficient to hold the candle wick once fully cured.

2. The container of claim 1, wherein the container is formed of glass.

3. The container of claim 2, wherein the artwork area encompasses a majority of the cylindrical wall from the sealed based to the upper rim.

4. The container of claim 2, wherein the rectangular piece of artwork is a piece of acrylic artwork formed by an acrylic pour process and from acrylic paint.

5. The container of claim 4, wherein the piece of acrylic artwork is peeled or pulled away from a first painting substrate prior to being applied to the first adhesive mixture.

6. The container of claim 5, wherein the peeled or pulled piece of acrylic artwork is trimmed to match the dimensions of the artwork area.

7. The container of claim 6, wherein the first adhesive mixture and the second adhesive mixture are fully cured mixtures of adhesive.

8. The container of claim 7, wherein the fully cured mixtures of adhesive were formed of equal parts of water and clear glue prior to fully curing.

9. The container of claim 8, wherein the sealant layer is a fully cured layer of sealant.

10. The container of claim 9, wherein the fully cured layer of sealant is an epoxy material.

11. A candle container comprising a sealed based, a cylindrical wall extending from the base, and an upper rim formed on the cylindrical wall, the candle container having an interior cavity defined by the sealed base, cylindrical wall, and upper rim, the candle container formed by a process of:
applying a first adhesive mixture to an artwork area, the artwork are encompassing a portion of the cylindrical wall;
applying a rectangular piece of original artwork onto the first adhesive mixture prior to the first adhesive mixture curing;
applying a second adhesive mixture onto the rectangular piece of original artwork;
applying a sealant layer applied onto the second adhesive mixture; and
at least partially filling, to approximately below the upper rim, the interior cavity with at least one candle wick and a measure of candle wax sufficient to hold the candle wick once fully cured.

12. The candle container of claim 11, wherein the container is formed of glass.

13. The candle container of claim 12, wherein the artwork area encompasses a majority of the cylindrical wall from the sealed based to the upper rim.

14. The candle container of claim 12, wherein the rectangular piece of artwork is a piece of acrylic artwork formed by an acrylic pour process and from acrylic paint.

15. The candle container of claim 14, wherein the piece of acrylic artwork is peeled or pulled away from a first painting substrate prior to being applied to the first adhesive mixture.

16. The candle container of claim 15, wherein the peeled or pulled piece of acrylic artwork is trimmed to match the dimensions of the artwork area.

17. The candle container of claim 16, wherein the first adhesive mixture and the second adhesive mixture are not fully cured when applying the original artwork and the sealant layer, respectfully.

18. The candle container of claim 17, wherein the first adhesive mixture and the second adhesive mixture are formed of equal parts water and clear glue.

19. The candle container of claim 18, wherein the sealant layer is allowed to fully cure prior to filling the interior cavity.

20. The candle container of claim 19, wherein the sealant layer is an epoxy material.
